(19) United States
(12) Patent Application Publication
(10) Pub. No.: US 2022/0389746 A1
(43) Pub. Date: Dec. 8, 2022

(54) VEHICLE OPENING AND CLOSING BODY CONTROL DEVICE

(71) Applicant: AISIN CORPORATION, Kariya (JP)

(72) Inventors: Yuji NISHI, Kariya-shi (JP); Isao HONDA, Kariya-shi (JP); Kenta IZUMI, Kariya-shi (JP); Takeshi NISHIKIBE, Kariya-shi (JP)

(73) Assignee: AISIN CORPORATION, Kariya (JP)

(21) Appl. No.: 17/664,472

(22) Filed: May 23, 2022

(30) Foreign Application Priority Data
Jun. 8, 2021 (JP) 2021-096137

(51) Int. Cl. E05F 17/00; B60J 5/06; B60J 5/04; E05F 15/70

(52) U.S. Cl. CPC E05F 17/002; B60J 5/062; B60J 5/0477; E05F 15/70; E05F 2017/005; E05Y 2400/415; E05Y 2400/36; E05Y 2400/32; E05Y 2900/531

(57) ABSTRACT

A vehicle opening and closing body control device includes a full close control unit configured to cause first and second opening and closing bodies that are provided at an opening portion of a vehicle and execute opening and closing operations in opposite directions to execute the closing operations to a fully closed position. The full close control unit is configured to cause the second opening and closing body to execute the closing operation at an operation speed slower than that of the first opening and closing body.

### CROSS REFERENCE TO RELATED APPLICATIONS

This application is based on and claims priority under 35 U.S.C. § 119 to Japanese Patent Application 2021-096137, filed on Jun. 8, 2021, the entire content of which is incorporated herein by reference.

### TECHNICAL FIELD

This disclosure relates to a vehicle opening and closing body control device.

### BACKGROUND DISCUSSION

In the related art, there is a vehicle opening and closing body control device that controls a pair of opening and closing bodies having a so-called double-opening configuration in which opening and closing operations are executed in opposite directions. For example, an electric vehicle disclosed in JP 2021-6444A (Reference 1) opens and closes a door opening portion provided on a side surface of a vehicle body by using two sliding doors having the double-opening configuration. Accordingly, by ensuring a large door opening, an occupant can smoothly get on and off.

Some of such double-opening opening and closing bodies are arranged at a fully closed position in a state in which closing side ends thereof overlap each other. Accordingly, by increasing a blocking property in a fully closed state, excellent sound insulation performance and water stopping performance can be ensured.

However, in the configuration in which the pair of opening and closing bodies are arranged in the fully closed position in the state in which the closing side ends overlap each other as described above, an order in which the opening and closing bodies reach the fully closed position may be structurally restricted. In such a case, depending on the order restriction, the pair of opening and closing bodies having the double-opening configuration may interfere with each other during full close control.

### SUMMARY

According to an aspect of this disclosure, a vehicle opening and closing body control device includes a full close control unit configured to cause first and second opening and closing bodies that are provided at an opening portion of a vehicle and execute opening and closing operations in opposite directions to execute the closing operations to a fully closed position, in which the full close control unit is configured to cause the second opening and closing body to execute the closing operation at an operation speed slower than that of the first opening and closing body.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle including two sliding doors having a double-opening configuration;

FIG. 2 is a plan view schematically illustrating opening and closing operations of each sliding door provided at a door opening portion of the vehicle;

FIG. 3 is a control block diagram of the vehicle;

FIG. 4 illustrates a graph of operation speed target values individually set for each sliding door;

FIG. 5 is a flowchart illustrating a processing procedure of condition determination for starting full close control;

FIG. 6 is a flowchart illustrating a processing procedure of full close control for causing a first opening and closing body to execute the closing operation to a fully closed position;

FIG. 7 is a flowchart illustrating a processing procedure of full close control for causing a second opening and closing body to execute the closing operation to the fully closed position;

FIG. 8 is a flowchart illustrating a mode of interlocking control of the sliding door, a slope device, and a vehicle height adjustment device;

FIG. 9 is a block diagram illustrating a configuration of a door control unit according to a second embodiment;

FIG. 10 is a flowchart illustrating a processing procedure of interference possibility determination and interference prevention control;

FIG. 11 is an operation explanatory diagram illustrating a mode of the interference possibility determination and the interference prevention control;

FIG. 12 is a flowchart illustrating a modification of the interference possibility determination and the interference prevention control;

FIG. 13 is a flowchart illustrating another modification of the interference prevention control;

FIG. 14 is a flowchart illustrating another modification of the interference possibility determination; and

FIG. 15 is a flowchart illustrating another modification of the interference prevention control.

### DETAILED DESCRIPTION

### First Embodiment

Hereinafter, a vehicle opening and closing body control device according to a first embodiment will be described with reference to the drawings.

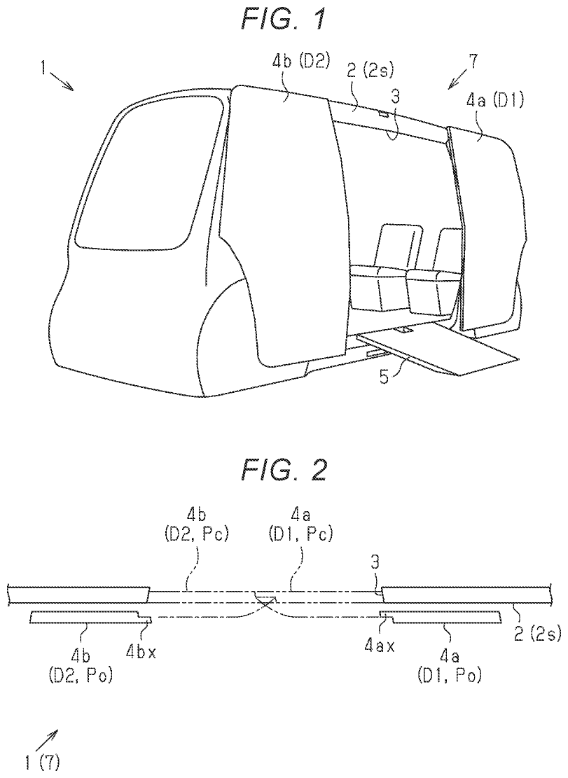

As illustrated in FIGS. 1 and 2, a vehicle 1 according to the present embodiment includes a substantially rectangular box-shaped vehicle body 2 extending in a vehicle front-rear direction. A side surface 2s of the vehicle body 2 is provided with a door opening portion 3 serving as an entrance and exit for an occupant. The door opening portion 3 is provided with two sliding doors 4a and 4b having a so-called double-opening configuration in which opening and closing operations are executed in opposite directions.

That is, in FIG. 2, one sliding door 4a located on a right side executes the closing operation by moving to a left side, and executes the opening operation by moving to the right side in FIG. 2. Meanwhile, in FIG. 2, the other sliding door 4b located on the left side executes the closing operation by moving to the right side, and executes the opening operation by moving to the left side in FIG. 2. Further, the sliding doors 4a and 4b are configured as a power sliding door device 7 which executes the opening and closing operations based on a driving force of an actuator (not illustrated). The vehicle 1 according to the present embodiment opens and closes the door opening portion 3 in such a manner that the sliding doors 4a and 4b are interlocked with each other.

In detail, in the vehicle 1 according to the present embodiment, the sliding doors 4a and 4b execute the opening and closing operations in the vehicle front-rear direction while being displaced in a vehicle width direction. Specifically, each of the sliding doors 4a and 4b is configured to be substantially flush with the side surface 2s of the vehicle body 2 when each of the sliding doors 4a and 4b is at a fully closed position Pc (a position indicated by a two-dot chain line in FIG. 2). Further, each of the sliding doors 4a and 4b executes the opening operation from the fully closed position Pc while being displaced outward in the vehicle width direction (a lower side in FIG. 2). Accordingly, in the vehicle 1 according to the present embodiment, the sliding doors 4a and 4b that execute the opening operation do not interfere with the side surface 2s of the vehicle body 2.

In the vehicle 1 according to the present embodiment, the sliding doors 4a and 4b are each arranged at the fully closed position Pc in a state in which closing side ends 4ax and 4bx of the sliding doors 4a and 4b overlap each other. Specifically, the closing side ends 4ax and 4bx are each arranged at the fully closed position Pc so as to overlap each other in a state in which the closing side end 4ax of the one sliding door 4a is located on an inner side in the vehicle width direction (an upper side in FIG. 2), and the closing side end 4bx of the other sliding door 4b is located on an outer side in the vehicle width direction (the lower side in FIG. 2). Accordingly, the vehicle 1 according to the present embodiment ensures excellent sound insulation performance and water stopping performance by increasing a blocking property in a fully closed state in which each of the sliding doors 4a and 4b is arranged at the fully closed position Pc.

As illustrated in FIG. 1, the vehicle 1 according to the present embodiment includes a slope device 5 deployed at a lower end of the door opening portion 3 when the door opening portion 3 is in a fully open state. The slope device 5 has a configuration as a power slope device that is deployed by being driven by an actuator (not illustrated) and stored in the vehicle body 2. By using the slope device 5, the vehicle 1 according to the present embodiment allows the occupant to easily get on and off the door opening portion 3 even if the occupant is, for example, a user of a wheelchair, a carrier with wheels, or a bicycle.

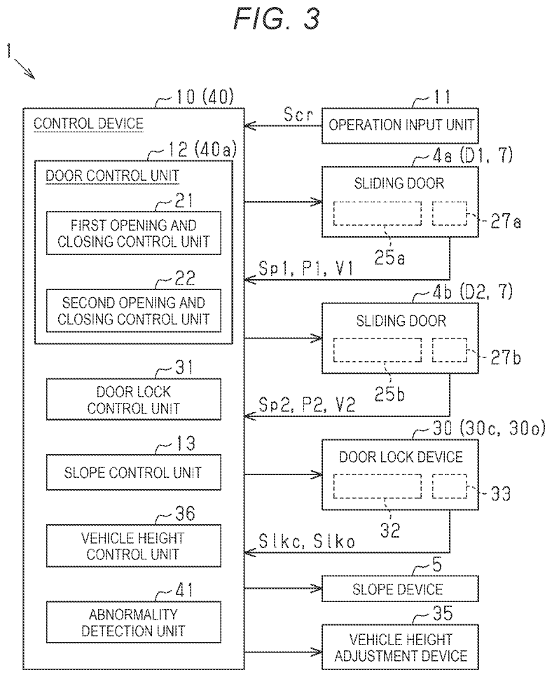

As illustrated in FIG. 3, in the vehicle 1 according to the present embodiment, operations of the sliding doors 4a and 4b constituting the power sliding door device 7 are controlled by a control device 10, together with the slope device 5.

In detail, for example, an operation input signal Scr for an operation input unit 11 provided in the vehicle 1 such as a driver seat (not illustrated) is input to the control device 10 according to the present embodiment. That is, in the vehicle 1 according to the present embodiment, operation requests for the sliding doors 4a and 4b and an operation request for the slope device 5 are input to the control device 10 as the operation input signal Scr. The control device 10 according to the present embodiment includes a door control unit 12 that controls the opening and closing operations of the sliding doors 4a and 4b, and a slope control unit 13 that controls the deployment and storage operations of the slope device 5, based on these operation requests.

Specifically, in the control device 10 according to the present embodiment, the door control unit 12 includes a first opening and closing control unit 21 that sets the one sliding door 4a of the two sliding doors 4a and 4b having the so-called double-opening configuration as described above as a first opening and closing body D1, and controls the operation of the first opening and closing body D1. The door control unit 12 includes a second opening and closing control unit 22 that sets the other sliding door 4b of the two sliding doors 4a and 4b as a second opening and closing body D2, and controls the operation the second opening and closing body D2. That is, the vehicle 1 according to the present embodiment is provided with a first door actuator 25a and a second door actuator 25b for independently driving the sliding doors 4a and 4b, respectively. In the door control unit 12 according to the present embodiment, the first opening and closing control unit 21 and the second opening and closing control unit 22 cause the sliding doors 4a and 4b to execute the opening and closing operations through operations of the respective first door actuator 25a and second door actuator 25b.

In more detail, a pulse signal Sp1 synchronized with the opening and closing operations of the sliding door 4a serving as the first opening and closing body D1, which is output by a first pulse sensor 27a provided integrally with the first door actuator 25a, is input to the control device 10 according to the present embodiment. A pulse signal Sp2 synchronized with the opening and closing operations of the sliding door 4b serving as the second opening and closing body D2, which is output by a second pulse sensor 27b provided integrally with the second door actuator 25b, is input to the control device 10. Further, the control device 10 according to the present embodiment detects operation positions P1 and P2 and operation speeds V1 and V2 of the sliding doors 4a and 4b by counting each of these pulse signals Sp1 and Sp2. Based on the operation positions P1 and P2 and the operation speeds V1 and V2, the first opening and closing control unit 21 and the second opening and closing control unit 22 constituting the door control unit 12 independently control the opening and closing operations of the sliding doors 4a and 4b.

The control device 10 according to the present embodiment includes a door lock control unit 31 that controls an operation of a door lock device 30 provided in the vehicle 1. Specifically, in the vehicle 1 according to the present embodiment, as the door lock device 30, a full close lock 30c that restrains the sliding doors 4a, 4b at the fully closed positions Pc, and a full open lock 30o that restrains the sliding doors 4a, 4b at fully open positions Po are provided. Further, a full close latch signal Slkc and a full open latch signal Slko are input to the control device 10 according to the present embodiment as output signals of a latch switch 33 indicating an operation state of a latch mechanism 32 constituting the door lock device 30. The control device 10 according to the present embodiment starts opening operation control and closing operation control of the sliding doors 4a and 4b by the door control unit 12 based on the full close latch signal Slkc and the full open latch signal Slko.

Further, the control device 10 according to the present embodiment includes a vehicle height control unit 36 that controls an operation of a vehicle height adjustment device 35 provided in the vehicle 1. Accordingly, in the vehicle 1 according to the present embodiment, a vehicle height can be adjusted in conjunction with the opening and closing operations of the sliding doors 4a and 4b and the deployment and storage operations of the slope device 5.

### Full Close Control of Sliding Door

Next, full close control of the sliding doors 4a and 4b executed by the door control unit 12 of the present embodiment will be described.

As described above, in the vehicle 1 according to the present embodiment, the sliding doors 4a and 4b execute the opening and closing operations in the vehicle front-rear direction while being displaced in the vehicle width direction (see FIG. 2). The sliding doors 4a and 4b are arranged at the fully closed positions Pc in a state in which the closing side ends 4ax and 4bx of the sliding doors 4a and 4b overlap each other. As a result, the sliding doors 4a and 4b are structurally restricted in an order of reaching the fully closed position Pc.

That is, when the sliding doors 4a and 4b are caused to execute the opening operations from the fully closed positions Pc, the other sliding door 4b in which the closing side end 4bx is located on the outer side in the vehicle width direction is caused to execute the opening operation earlier than the one sliding door 4a in which the closing side end 4ax is located on the inner side in the vehicle width direction. When the sliding doors 4a and 4b are caused to execute the closing operation to the fully closed positions Pc, the one sliding door 4a is caused to reach the fully closed position Pc earlier than the other sliding door 4a. Accordingly, interference between the sliding doors 4a and 4b can be avoided based on a structural order restriction.

Based on this point, the door control unit 12 according to the present embodiment sets a speed difference between the operation speeds V1 and V2 of the sliding doors 4a and 4b in the full close control for causing the sliding doors 4a and 4b to execute the closing operations to the fully closed positions Pc. That is, in most of sliding door devices having the double-opening configuration, including the vehicle 1 according to the present embodiment, the first and second opening and closing bodies D1 and D2 that execute the opening and closing operations in opposite directions have substantially the same opening and closing operation distance. Therefore, by executing the full close control in which the speed difference is set for the first and second opening and closing bodies D1 and D2, one of the first and second opening and closing bodies D1 and D2 can be caused to reach the fully closed position Pc at a timing earlier than the other. The door control unit 12 provided in the control device 10 serving as a vehicle opening and closing body control device 40 prevents, by using the speed difference, the interference between the two sliding doors 4a and 4b having the double-opening configuration during the full close control.

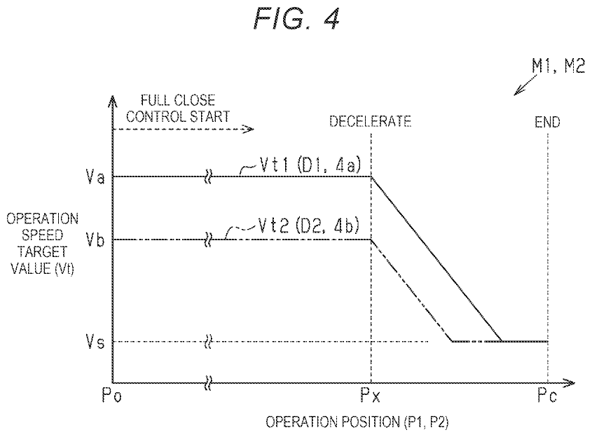

In detail, as illustrated in FIG. 4, the door control unit 12 sets the one sliding door 4a that preferentially reaches the fully closed position Pc due to the above order restriction as the first opening and closing body D1, and sets a smaller operation speed target value Vt to the other sliding door 4b serving as the second opening and closing body D2.

Specifically, in the door control unit 12 according to the present embodiment, the first opening and closing control unit 21 sets a first speed Va as an operation speed target value Vt1 for the sliding door 4a serving as the first opening and closing body D1 to be controlled (Vt1=Va). The second opening and closing control unit 22 sets a second speed Vb that is slower than that of the sliding door 4a constituting the first opening and closing body D1 as an operation speed target value Vt2 for the sliding door 4b serving as the second opening and closing body D2 to be controlled (Vt2=Vb<Va). Then, the first opening and closing control unit 21 and the second opening and closing control unit 22 independently execute the full close control of the respective first and second opening and closing bodies D1 and D2 based on the individually set operation speed target values Vt1 and Vt2.

In the door control unit 12 according to the present embodiment, the first opening and closing control unit 21 executes feedback control to cause the actual operation speed V1 to follow the operation speed target value Vt1 set for the first opening and closing body D1 during the full close control, thereby driving the first opening and closing body D1 to close. The second opening and closing control unit 22 also executes feedback control to cause the actual operation speed V2 to follow the operation speed target value Vt2 set for the second opening and closing body D2 during the full close control, thereby driving the second opening and closing body D2 to close. Accordingly, the door control unit 12 according to the present embodiment causes the sliding door 4b serving as the second opening and closing body D2 to execute the closing operation to the fully closed position Pc at an operation speed slower than that of the sliding door 4a serving as the first opening and closing body D1.

The door control unit 12 according to the present embodiment keeps the respective operation speed target values Vt1 and Vt2 set individually constant until the sliding doors 4a and 4b reach deceleration positions Px set in the vicinity of the fully closed position Pc (Vt1=Va, Vt2=Vb). Further, after the sliding doors 4a and 4b reach the deceleration positions Px, the door control unit 12 gradually reduces the operation speed target values Vt1 and Vt2 of the sliding doors 4a and 4b to a predetermined terminal speed Vs. Accordingly, in the vehicle 1 according to the present embodiment, a so-called slow stop function is implemented in which the sliding doors 4a and 4b constituting the power sliding door device 7 gently move to the fully closed positions Pc.

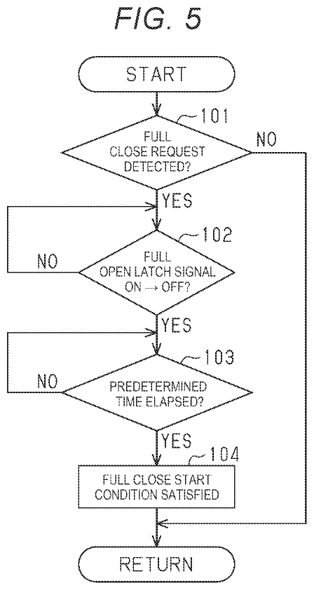

In more detail, as illustrated in a flowchart of FIG. 5, when the door control unit 12 according to the present embodiment detects full close requests for the sliding doors 4a and 4b based on the operation input signal Scr (step 101), the door control unit 12 first checks the full open latch signal Slko. Specifically, the door control unit 12 determines whether the full open latch signal Slko changes from “ON” to “OFF” (step 102). That is, in the control device 10 according to the present embodiment, when the full close requests for the sliding doors 4a and 4b based on the operation input signal Scr are detected, first, the door lock control unit 31 executes release control of the full open lock 300. Further, in the vehicle 1 according to the present embodiment, since the restraints of the sliding doors 4a, 4b by the full open lock 30o are released, the full open latch signal Slko changes from “ON” to “OFF”. Accordingly, the door control unit 12 according to the present embodiment confirms the release of the restraint of each of the sliding doors 4a, 4b by the full open lock 300.

Further, in the control device 10 according to the present embodiment, after the full open latch signal Slko changes from “ON” to “OFF” (step 102: YES), the door control unit 12 determines whether a predetermined time elapses (step 103). In the vehicle 1 according to the present embodiment, the predetermined time is set to, for example, about several tens of milliseconds. Then, after the predetermined time elapses (step 103: YES), the door control unit 12 according to the present embodiment determines that a full close start condition is satisfied (step 104). That is, the door control unit 12 confirms that the sliding doors 4a and 4b can be caused to execute the closing operations from the fully open positions Po.

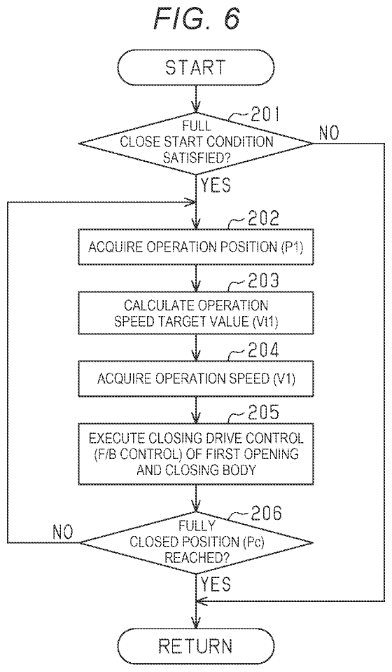

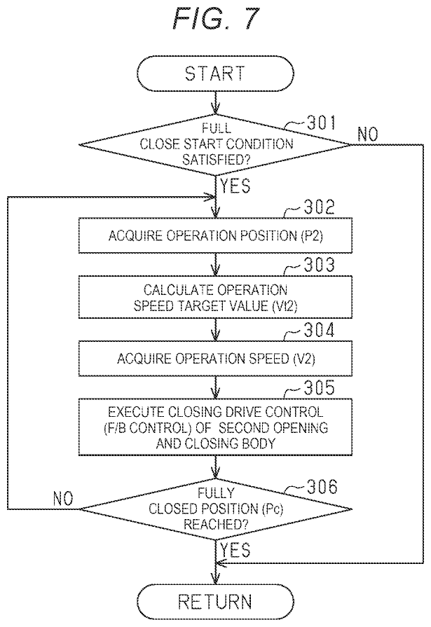

As illustrated in flowcharts of FIGS. 6 and 7, in the control device 10 according to the present embodiment, when the full close start condition is satisfied, the first opening and closing control unit 21 starts the full close control of the corresponding sliding door 4a (step 201: YES). Further, the second opening and closing control unit 22 also starts the full close control of the sliding door 4b corresponding to the second opening and closing control unit 22 (step 301: YES). Accordingly, the door control unit 12 according to the present embodiment simultaneously starts the full close control of the sliding doors 4a and 4b constituting the first and second opening and closing bodies D1 and D2.

Specifically, the first opening and closing control unit 21 acquires the operation position P1 of the sliding door 4a serving as the first opening and closing body D1 (step 202), and calculates the operation speed target value Vt1 corresponding to the operation position P1 (step 203). In the door control unit 12 according to the present embodiment, a control map M1 of the operation speed target value Vt1 as illustrated in FIG. 4 is stored in a storage area (not illustrated). The first opening and closing control unit 21 calculates the operation speed target value Vt1 of the sliding door 4a corresponding to the operation position P1 by referring to the operation position P1 of the sliding door 4a acquired in step 202 with respect to the control map M1.

Next, the first opening and closing control unit 21 acquires the actual operation speed V1 detected for the sliding door 4a to be controlled (step 204). Subsequently, the first opening and closing control unit 21 executes closing drive control of the sliding door 4a serving as the first opening and closing body D1 based on the operation speed target value Vt1 calculated in step 203 and the actual operation speed V1 acquired in step 204 (step 205). Then, the first opening and closing control unit 21 according to the present embodiment determines whether the sliding door 4a reaches the fully closed position Pc (step 206).

That is, if the sliding door 4a serving as the first opening and closing body D1 to be controlled does not reach the fully closed position Pc (step 206: NO), the first opening and closing control unit 21 according to the present embodiment repeatedly executes the processing of steps 202 to 206. If the first opening and closing control unit 21 determines that the sliding door 4a reaches the fully closed position Pc (step 206: YES), the full close control of the sliding door 4a ends.

Meanwhile, the second opening and closing control unit 22 also acquires the operation position P2 of the sliding door 4a serving as the second opening and closing body D2 to be controlled (step 302), calculates the operation speed target value Vt2 (step 303), and acquires the actual operation speed V2 (step 304). The calculation of the operation speed target value Vt2 by the second opening and closing control unit 22 is also executed by referring to the operation position P2 of the sliding door 4b with respect to a control map M2 of the operation speed target value Vt2 stored in the storage area (not illustrated) (see FIG. 4). Then, the second opening and closing control unit 22 executes closing drive control based on the operation speed target value Vt2 and the actual operation speed V2 (step 305), and determines whether the sliding door 4b reaches the fully closed position Pc (step 306).

That is, if the sliding door 4b serving as the second opening and closing body D2 to be controlled does not reach the fully closed position Pc (step 306: NO), the second opening and closing control unit 22 repeatedly executes the processing of steps 302 to 306. If the second opening and closing control unit 22 determines that the sliding door 4b reaches the fully closed position Pc (step 306: YES), the full close control of the sliding door 4b ends.

In this way, the control device 10 according to the present embodiment executes the full close control in which the speed difference is set for the first and second opening and closing bodies D1 and D2. Accordingly, in the power sliding door device 7 according to the present embodiment, the one sliding door 4a that preferentially reaches the fully closed position Pc due to the structural order restriction reaches the fully closed position Pc at a timing earlier than that of the other sliding door 4b.

As described above, the control device 10 according to the present embodiment causes opening and closing control of the sliding doors 4a and 4b by the door control unit 12, deployment and storage control of the slope device 5 by the slope control unit 13, and vehicle height adjustment control of the vehicle 1 by the vehicle height control unit 36 to interlock with each other. The control device 10 according to the present embodiment further includes an abnormality detection unit 41 that detects an abnormality occurred in the power sliding door device 7, the slope device 5, and the vehicle height adjustment device 35 (see FIG. 3). Examples of abnormality detection determination executed by the abnormality detection unit 41 according to the present embodiment include occurrence of pinching, malfunction due to inconsistency in an operation timing, and the like. The control device 10 according to the present embodiment also executes so-called fail-safe control when such an abnormality is detected, in which the power sliding door device 7, the slope device 5, and the vehicle height adjustment device 35 are interlocked with each other.

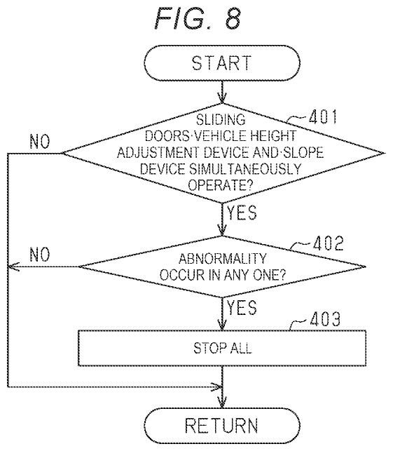

Specifically, as illustrated in a flowchart of FIG. 8, the control device 10 according to the present embodiment determines whether the sliding doors 4a and 4b, the slope device 5, and the vehicle height adjustment device 35 simultaneously operate (step 401). If the sliding doors 4a and 4b, the slope device 5, and the vehicle height adjustment device 35 simultaneously operate (step 401: YES), the control device 10 determines whether the abnormality is detected in any one of the sliding doors 4a and 4b, the slope device 5, and the vehicle height adjustment device 35 (step 402). If the abnormality is detected in any one of the sliding doors 4a and 4b, the slope device 5, and the vehicle height adjustment device 35 (step 402: YES), the control device 10 according to the present embodiment stops all of the sliding doors 4a and 4b, the slope device 5, and the vehicle height adjustment device 35 that are operating (step 403).

Next, operations of the present embodiment will be described.

In the vehicle 1, the door opening portion 3 is opened and closed by the two sliding doors 4a and 4b having the double-opening configuration. In the sliding doors 4a and 4b, due to the structural order restriction, the one sliding door 4a is set as the first opening and closing body D1, and the sliding door 4a is caused to reach the fully closed position Pc more preferentially than the other sliding door 4b serving as the second opening and closing body D2. In order to satisfy this order restriction, the other sliding door 4b serving as the second opening and closing body D2 executes the closing operation to the fully closed position Pc at an operation speed slower than that of the one sliding door 4a located in the first opening and closing body D1 (V1>V2).

Next, effects according to the present embodiment will be described.

(1) In the vehicle 1, as an opening portion for the occupant to get on and off, the door opening portion 3 is formed on the side surface 2s of the vehicle body 2. The door opening portion 3 is provided with two sliding doors 4a and 4b having the so-called double-opening configuration in which the opening and closing operations are executed in opposite directions. Further, the opening and closing operations of the sliding doors 4a and 4b are independently controlled by the door control unit 12 provided in the control device 10 serving as the vehicle opening and closing body control device 40. During the full close control, the door control unit 12 serving as a full close control unit 40a causes the other sliding door 4b serving as the second opening and closing body D2 to execute the closing operation to the fully closed position Pc at an operation speed slower than that of the one sliding door 4a located at the first opening and closing body D1.

According to the above configuration, the one sliding door 4a that preferentially reaches the fully closed position Pc due to the structural order restriction can be set as the first opening and closing body D1, and can be caused to reach the fully closed position Pc at a timing earlier than that of the other sliding door 4b serving as the second opening and closing body D2. Accordingly, the interference between the two sliding doors 4a and 4b having the double-opening configuration can be prevented during the full close control.

Further, since the interference between the sliding doors 4a and 4b is prevented, a ratio of a state in which the sliding doors 4a and 4b simultaneously execute the closing operations can be increased. As a result, it is possible to reduce a so-called “waiting feeling” caused by a state in which one of the two sliding doors 4a and 4b does not execute the closing operation. Accordingly, it is possible to give a good impression to the user.

(2) During the full close control, the door control unit 12 individually sets the operation speed target values Vt1 and Vt2 for the sliding doors 4a and 4b serving as the first and second opening and closing bodies D1 and D2. Then, the door control unit 12 independently executes the feedback control to cause the actual operation speeds V1 and V2 to follow the operation speed target values Vt1 and Vt2 set individually. Accordingly, the speed difference can be set for the sliding doors 4a and 4b based on the setting of the operation speed target values Vt1 and Vt2 executed individually.

(3) As the door lock device 30, the vehicle 1 is provided with the full open lock 30o that restrains the sliding doors 4a and 4b at the fully open positions Po. Further, the full open latch signal Slko indicating the operation state of the latch mechanism 32 constituting the door lock device 30 is input to the control device 10. The door control unit 12 starts the full close control by confirming that the sliding doors 4a, 4b are in a state of being able to execute the closing operations from the fully open positions Po based on the change of the full open latch signal Slko.

That is, it is possible to quickly start the full close control by the door control unit by detecting, based on the full open latch signal Slko, that the restraints of the sliding doors 4a, 4b by the full open lock 30o are actually released. Accordingly, the “waiting feeling” can be further reduced.

(4) The control device 10 stops all of the sliding doors 4a and 4b, the slope device 5, and the vehicle height adjustment device 35 if the abnormality is detected in any one of the sliding doors 4a and 4b, the slope device 5, and the vehicle height adjustment device 35 during simultaneous operation. Accordingly, high safety can be ensured.

### Second Embodiment

Hereinafter, a vehicle opening and closing body control device according to a second embodiment will be described with reference to the drawings. For convenience of description, the same components as those of the first embodiment are denoted by the same reference numerals, and descriptions thereof will be omitted.

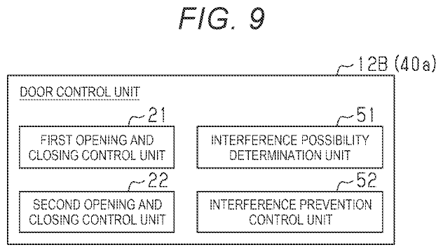

As illustrated in FIG. 9, a door control unit 12B according to the present embodiment includes an interference possibility determination unit 51 that determines, by monitoring a closing operation of each of the sliding doors 4a and 4b, a possibility of occurrence of an interference when the sliding doors 4a and 4b reach the fully closed positions Pc. The door control unit 12B further includes an interference prevention control unit 52 that executes interference prevention control for avoiding the interference when the interference possibility determination unit 51 determines that there is a possibility that the sliding doors 4a and 4b interfere with each other. Specifically, as the interference prevention control, the interference prevention control unit 52 according to the present embodiment adjusts the operation speed V2 of the sliding door 4b serving as the second opening and closing body D2. Accordingly, the door control unit 12B according to the present embodiment causes the other sliding door 4b serving as the second opening and closing body D2 to reach the fully closed position Pc at a later timing after the one sliding door 4a serving as the first opening and closing body D1 reaches the fully closed position Pc.

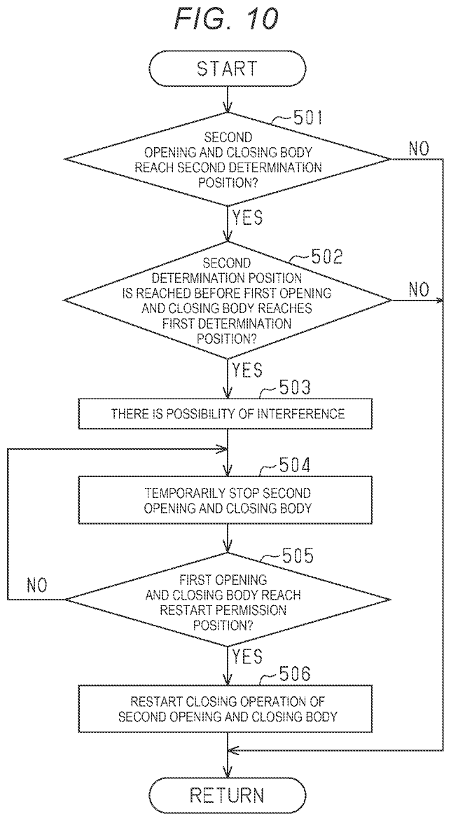

In detail, as illustrated in a flowchart of FIG. 10 and FIG. 11, the interference possibility determination unit 51 according to the present embodiment sets a first determination position Pj1 for determining the interference possibility of the one sliding door 4a serving as the first opening and closing body D1 during the full close control. The interference possibility determination unit 51 also sets a second determination position Pj2 for determining the interference possibility of the other sliding door 4b serving as the second opening and closing body D2. In the vehicle 1 according to the present embodiment, the first and second determination positions Pj1 and Pj2 are set in the vicinity of the fully closed positions Pc, respectively. Further, the first determination position Pj1 is set to a position closer to the fully closed position Pc in comparison with the second determination position Pj2. When the sliding door 4b serving as the second opening and closing body D2 reaches the second determination position Pj2 before the sliding door 4a serving as the first opening and closing body D1 reaches the first determination position Pj1, the interference possibility determination unit 51 determines that there is a possibility that the sliding doors 4a and 4b interfere with each other.

Specifically, in the door control unit 12B according to the present embodiment, the interference possibility determination unit 51 first determines whether the sliding door 4b serving as the second opening and closing body D2 reaches the second determination position Pj2 (step 501). If the interference possibility determination unit 51 determines that the sliding door 4b reaches the second determination position Pj2 (step 501: YES), the interference possibility determination unit 51 determines whether the sliding door 4b reaches the second determination position Pj2 before the sliding door 4a serving as the first opening and closing body D1 reaches the first determination position Pj1 (step 502). If the sliding door 4b reaches the second determination position Pj2 before the sliding door 4a reaches the first determination position Pj1 (step 502: YES), the interference possibility determination unit 51 according to the present embodiment determines that there is a possibility that the sliding doors 4a and 4b that reach the fully closed positions Pc interfere with each other (step 503).

In the door control unit 12B according to the present embodiment, when the interference possibility determination unit 51 determines in step 503 that there is a possibility of the interference, the interference prevention control unit 52 executes the interference prevention control. Specifically, the interference prevention control unit 52 according to the present embodiment temporarily stops the sliding door 4b serving as the second opening and closing body D2 (step 504). In the door control unit 12B according to the present embodiment, the temporary stop control is executed by the second opening and closing control unit 22 stopping closing drive control (see FIG. 7, step 305) of the sliding door 4b serving as the second opening and closing body D2. The interference prevention control unit 52 according to the present embodiment continues the temporary stop control of the second opening and closing body D2 which is executed as the interference prevention control by adjusting the operation speed V2 until a predetermined restart condition is satisfied.

In more detail, as illustrated in FIG. 11, the interference prevention control unit 52 according to the present embodiment sets, as the restart condition, that the sliding door 4a serving as the first opening and closing body D1 reaches a restart permission position Prs preset for the sliding door 4a serving as the first opening and closing body D1. Specifically, in the vehicle 1 according to the present embodiment, the restart permission position Prs is set to the fully closed position Pc. That is, the interference prevention control unit 52 according to the present embodiment restarts closing drive of the sliding door 4b when the sliding door 4a serving as the first opening and closing body D1 reaches the fully closed position Pc while the sliding door 4b serving as the second opening and closing body D2 is temporarily stopped. Accordingly, in the vehicle 1 according to the present embodiment, the interference with the sliding door 4a serving as the first opening and closing body D1 is prevented by the sliding door 4b serving as the second opening and closing body D2 restarting the closing operation toward the fully closed position Pc.

That is, as illustrated in FIG. 10, when the sliding door 4b serving as the second opening and closing body D2 is temporarily stopped by the interference prevention control, the interference prevention control unit 52 determines whether the sliding door 4a serving as the first opening and closing body D1 reaches the restart permission position Prs (step 505). If the sliding door 4a does not reach the restart permission position Prs (step 505: NO), the interference prevention control unit 52 according to the present embodiment repeats the processing of steps 504 and 505. If the one sliding door 4a reaches the restart permission position Prs (step 505: YES), the closing operation of the temporarily stopped other sliding door 4b is restarted (step 506).

That is, in the door control unit 12B according to the present embodiment, the closing drive control (see FIG. 7, step 305) of the sliding door 4b serving as the second opening and closing body D2 by the second opening and closing control unit 22 is permitted based on the restart determination by the interference prevention control unit 52. Accordingly, in the vehicle 1 according to the present embodiment, the sliding door 4b serving as the second opening and closing body D2 reaches the fully closed position Pc later than the sliding door 4a serving as the first opening and closing body D1.

As described above, according to the configuration of the present embodiment, the following effects can be achieved in addition to the effects of the first embodiment.

(1) The door control unit 12B includes the interference possibility determination unit 51 and the interference prevention control unit 52. The interference possibility determination unit 51 determines, by monitoring the closing operation of each of the sliding doors 4a and 4b, the possibility of the occurrence of the interference when the sliding doors 4a and 4b reach the fully closed positions Pc. When there is a possibility of the interference, the interference prevention control unit 52 adjusts the operation speed V2 of the sliding door 4b so that the sliding door 4b serving as the second opening and closing body D2 reaches the fully closed position Pc at a later timing.

According to the above configuration, even in a situation with a disturbance where it is difficult to control the operation speeds V1 and V2 as desired, the sliding door 4b serving as the second opening and closing body D2 can be caused to reach the fully closed position Pc at a timing later than that of the sliding door 4a serving as the first opening and closing body D1. Examples of the disturbance in this case include variation due to individual differences, such as temperature characteristics and sliding resistance, or inclination of a road surface. Accordingly, the interference between the two sliding doors 4a and 4b having a double-opening configuration can be prevented during the full close control.

(2) If the sliding door 4b serving as the second opening and closing body D2 reaches the second determination position Pj2 before the sliding door 4a serving as the first opening and closing body D1 reaches the first determination position Pj1, the interference possibility determination unit 51 determines that there is a possibility that the sliding door 4a and the sliding door 4b interfere with each other.

According to the above configuration, it is possible to determine, with a simple configuration, the possibility that the two sliding doors 4a and 4b having the double-opening configuration interfere with each other during the full close control. By setting the second determination position Pj2 at a position further away from the fully closed position Pc in comparison with the first determination position Pj1, it is easy to determine that there is a possibility that the sliding doors 4a and 4b interfere with each other. Accordingly, a large margin can be easily set for the interference prevention control.

(3) When there is a possibility that the sliding doors 4a and 4b interfere with each other, as the interference prevention control, the interference prevention control unit 52 temporarily stops the sliding door 4b serving as the second opening and closing body D2.

According to the above configuration, it is possible to more reliably delay the timing at which the sliding door 4b serving as the second opening and closing body D2 reaches the fully closed position Pc. Accordingly, the interference between the two sliding doors 4a and 4b having the double-opening configuration can be effectively prevented.

(4) When the sliding door 4a serving as the first opening and closing body D1 reaches the restart permission position Prs preset for the sliding door 4a, the interference prevention control unit 52 causes the sliding door 4b serving as the second opening and closing body D2 to restart the closing operation toward the fully closed position Pc.

According to the above configuration, it is possible to effectively cause the sliding door 4b serving as the second opening and closing body D2 to reach the fully closed position Pc later than the sliding door 4a serving as the first opening and closing body D1. As the restart permission position Prs is set to a position close to the fully closed position Pc, the interference between the sliding doors 4a and 4b serving as the first and second opening and closing bodies D1 and D2 that reach the fully closed positions Pc can be more effectively prevented.

Each of the above embodiments can be modified and implemented as follows. The embodiments and the following modifications can be implemented in combination with each other as long as the embodiments and the modifications do not have technical contradiction.

In the second embodiment, it is determined that there is a possibility that the sliding doors 4a and 4b interfere with each other if the sliding door 4b serving as the second opening and closing body D2 reaches the second determination position Pj2 before the sliding door 4a serving as the first opening and closing body D1 reaches the first determination position Pj1.

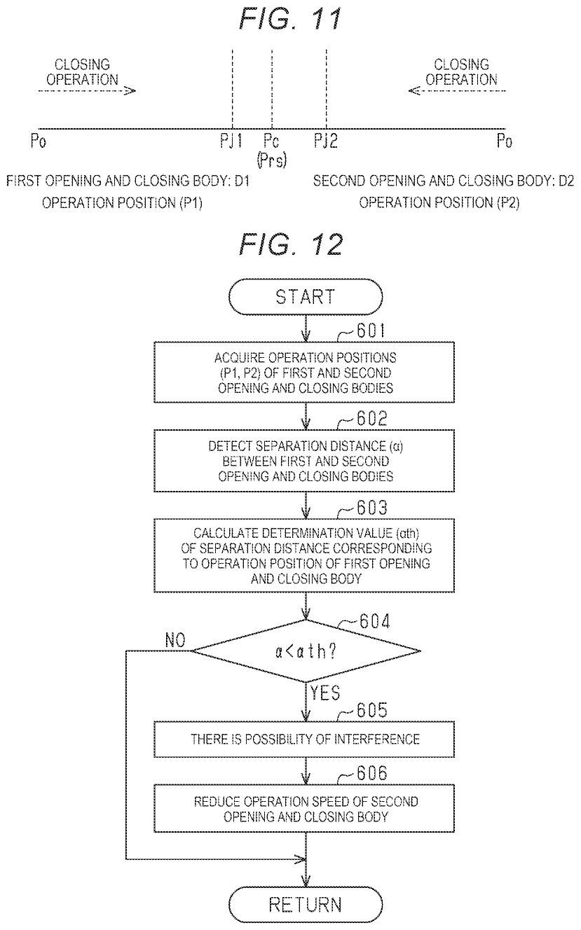

However, this disclosure is not limited thereto, and as illustrated in a flowchart of FIG. 12, the operation positions P1 and P2 of the first and second opening and closing bodies D1 and D2 are acquired (step 601). Next, based on the operation positions P1 and P2 of the first and second opening and closing bodies D1 and D2 acquired in step 601, a separation distance α between the first and second opening and closing bodies D1 and D2 approaching each other due to the execution of the full close control is detected (step 602). Further, a determination value αth of the separation distance α corresponding to the operation position P1 of the first opening and closing body D1 is calculated (step 603). The determination value αth may be calculated by using, for example, a predetermined calculation formula, or a map or a control table in which the operation position P1 of the first opening and closing body D1 and the determination value αth are associated with each other. If the separation distance α calculated in step 602 is smaller than the determination value αth (α<αth, step 604: YES), it may be determined that there is a possibility that the first and second opening and closing bodies D1 and D2 interfere with each other (step 605).

That is, if the operation speeds V1 and V2 of the first and second opening and closing bodies D1 and D2 can be controlled as desired, the separation distance α between the first and second opening and closing bodies D1 and D2 approaching each other due to the execution of the full close control should be a value corresponding to the operation position P1 of the first opening and closing body D1. Based on this point, the determination value αth corresponding to a theoretical value of the separation distance α corresponding to the operation position P1 of the first opening and closing body D1 is calculated. That is, if the actual separation distance α is smaller than the determination value αth, the closing operation of the second opening and closing body D2 toward the fully closed position Pc is estimated to be relatively early. Accordingly, it is possible to accurately determine the possibility that the first and second opening and closing bodies D1 and D2 interfere with each other during the full close control.

Further, in the modification illustrated in FIG. 12, when it is determined in step 605 that there is a possibility of the interference, as the interference prevention control, the operation speed V2 of the second opening and closing body D2 is reduced (step 606). The reduction control of the operation speed V2 is executed by reducing the operation speed target value Vt2. By adopting such a configuration, the second opening and closing body D2 can also be caused to reach the fully closed position Pc at a timing later than that of the first opening and closing body D1 regardless of the disturbance.

Based on the operation positions P1 and P2 of the first and second opening and closing bodies D1 and D2, the separation distance α between the first and second opening and closing bodies D1 and D2 approaching each other due to the execution of the full close control is detected. The operation speeds V1 and V2 of the first and second opening and closing bodies D1 and D2 may be controlled according to the separation distance α.

That is, if the operation speeds V1 and V2 are controlled based on the separation distance α between the first and second opening and closing bodies D1 and D2, it is not necessary to determine the possibility of the interference between the first and second opening and closing bodies D1 and D2. For example, the operation speeds V1 and V2 of the first and second opening and closing bodies D1 and D2 may be controlled to values predetermined according to the separation distance α. The operation speeds V1 and V2 may be controlled such that the separation distance α between the first and second opening and closing bodies D1 and D2 approaching each other gradually decreases according to a control target.

In the second embodiment, the temporary stop control of the second opening and closing body D2 is executed by stopping the closing drive control (see FIG. 7, step 305). However, this disclosure is not limited thereto, and the temporary stop control of the second opening and closing body D2 may be executed by correcting the operation speed target value Vt2 to “0” (Vt2=0).

In the second embodiment, when the sliding door 4b serving as the second opening and closing body D2 is temporarily stopped, whether the sliding door 4a serving as the first opening and closing body D1 reaches the restart permission position Prs is determined (see FIG. 10). When the one sliding door 4a reaches the restart permission position Prs (step 505: YES), the closing operation of the temporarily stopped other sliding door 4b is restarted (step 506).

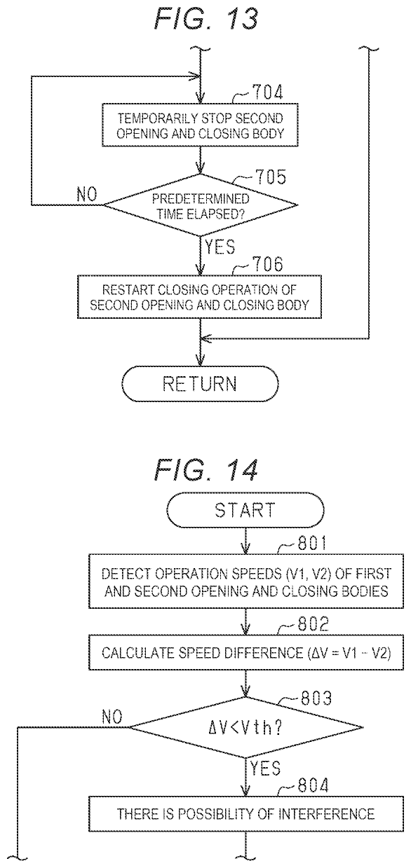

However, this disclosure is not limited thereto, as illustrated in a flowchart of FIG. 13, after the second opening and closing body D2 is temporarily stopped (step 704), when a predetermined time elapses (step 705: YES), the closing operation of the second opening and closing body D2 may be restarted (step 706). In the modification illustrated in FIG. 13, each of processings of steps 701 to 703 is the same as each of the processings of steps 501 to 503 illustrated in FIG. 10. The “predetermined time” in this case means an elapsed time from a time point at which the temporary stop control is started. By adopting such a configuration, the second opening and closing body D2 can also be caused to reach the fully closed position Pc at a timing later than that of the first opening and closing body D1 regardless of the disturbance.

When setting the restart permission position Prs, the setting of the restart permission position Prs is not limited to the fully closed position Pc, and may be freely changed.

Further, as illustrated in a flowchart of FIG. 14, the actual operation speeds V1 and V2 of the first and second opening and closing bodies D1 and D2 are detected (step 801), and a speed difference ΔV between the operation speeds V1 and V2 is calculated (ΔV=V1−V2, step 802). When the speed difference ΔV is smaller than a predetermined speed difference threshold value Vth (ΔV<Vth, step 803: YES), it may be determined that there is a possibility of the interference (step 804). By adopting such a configuration, it is also possible to accurately determine the possibility that the first and second opening and closing bodies D1 and D2 interfere with each other during the full close control.

As the speed difference threshold value Vth in this case, a predetermined constant value may be used, or a calculation value corresponding to the operation position P1 of the first opening and closing body D1 may be used. The speed difference threshold value Vth may be calculated by using, for example, a predetermined calculation formula, or a map or a control table in which the operation position P1 of the first opening and closing body D1 and the speed difference threshold value Vth are associated with each other.

In the embodiments and the modifications, as the interference prevention control, the operation speed V2 of the second opening and closing body D2 is decreased, including the temporary stop control thereof (V2=0). However, this disclosure is not limited thereto, and the operation speed V1 of the first opening and closing body D1 may be increased. The operation speed V1 of the first opening and closing body D1 may be increased while the operation speed V2 of the second opening and closing body D2 is decreased.

Further, after the full close control is started in a manner in which the operation speeds of the first and second opening and closing bodies D1 and D2 are the same (V1=V2), the speed difference (V1>V2) may be formed for the operation speeds V1 and V2 of the first and second opening and closing bodies D1 and D2 by the interference prevention control.

The interference possibility determination by the interference possibility determination unit 51 may be executed by a method other than the methods described in the embodiments and the modifications. For example, it may be determined that there is a possibility of the interference when the operation position P2 of the second opening and closing body D2 is closer to the fully closed position Pc than the theoretical value corresponding to the operation position P1 of the first opening and closing body D1. A plurality of interference possibility determination methods may be combined. As for the interference prevention control by the interference prevention control unit 52, the temporary stop control and the speed change control may selectively executed according to a situation. A combination of the interference possibility determination by the interference possibility determination unit 51 and the interference prevention control by the interference prevention control unit 52 may be freely changed.

In the embodiments, the full close control of the first and second opening and closing bodies D1 and D2 is simultaneously started. However, this disclosure is not limited thereto, and the second opening and closing body D2 may be caused to execute the closing operation at a start timing later than that of the first opening and closing body D1.

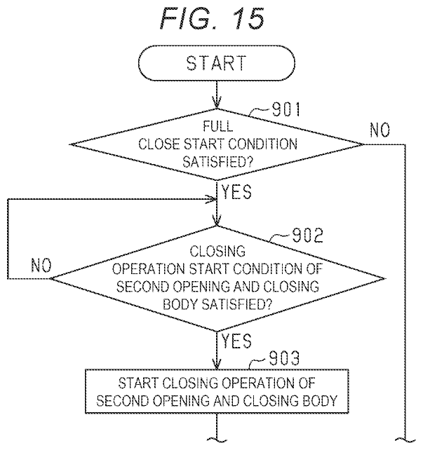

For example, as illustrated in a flowchart of FIG. 15, after the full close start condition is satisfied (step 901: YES, see FIG. 5), whether a closing operation start condition for the second opening and closing body D2 is satisfied is determined (step 902). It is conceivable that as the “closing operation start condition of the second opening and closing body”, for example, a predetermined time is elapsed from the satisfaction of the full close start condition in step 901, or the first opening and closing body D1 that starts the closing operation earlier reaches a predetermined start permission position. Then, after the closing operation start condition is satisfied (step 902: YES), the full close control of the second opening and closing body D2 may be started.

By adopting such a configuration, the interference between the two sliding doors 4a and 4b having the double-opening configuration can be effectively prevented. The start timing of the full close control of the second opening and closing body D2 may be delayed without setting the speed difference between the operation speeds V1 and V2 of the first and second opening and closing bodies D1 and D2.

In the embodiments, the full close control of the sliding doors 4a and 4b is started by detecting full close requests for the sliding doors 4a and 4b based on the operation input signal Scr for the operation input unit 11. However, this disclosure is not limited thereto, and may be embodied in a configuration in which the full close requests for the sliding doors 4a and 4b are automatically generated after detecting that the occupant completes getting on and off the vehicle 1.

The embodiments are embodied in a configuration in which the two sliding doors 4a and 4b having the double-opening configuration open and close the door opening portion 3 of the vehicle 1. However, this disclosure is not limited thereto, and may be embodied in a configuration in which, for example, doors of a type other than sliding doors, such as two swing doors and gliding doors, are used as the first and second opening and closing bodies D1 and D2 to open and close the door opening portion 3. This disclosure may be applied to a configuration in which the first and second opening and closing bodies D1 and D2 open and close an opening portion other than the door opening portion 3 provided in the vehicle 1.

In the embodiments, the first and second opening and closing bodies D1 and D2 are driven to close by executing the feedback control to cause the actual operation speeds V1 and V2 to follow the individually set operation speed target values Vt1 and Vt2. However, this disclosure is not limited thereto, and may be applied to a configuration in which the first and second opening and closing bodies D1 and D2 are driven to close by feedforward control.

Next, technical ideas that can be understood from the above embodiments and modifications will be described.

(A) A vehicle opening and closing body control device includes a full close control unit configured to cause first and second opening and closing bodies that are provided at an opening portion of a vehicle and execute opening and closing operations in opposite directions to execute the closing operations to a fully closed position, in which the full close control unit is configured to cause the second opening and closing body to execute the closing operation at a start timing later than that of the first opening and closing body. Accordingly, interference between a pair of opening and closing bodies having a double-opening configuration can be prevented during the full close control.

(B) The full close control unit is configured to restart the closing operation of the second opening and closing body after a predetermined time elapses after the closing operation of the second opening and closing body is temporarily stopped. Accordingly, the second opening and closing body can be caused to reach the fully closed position at a timing later than that of the first opening and closing body regardless of a disturbance.

According to an aspect of the disclosure, a vehicle opening and closing body control device includes a full close control unit configured to cause first and second opening and closing bodies that are provided at an opening portion of a vehicle and execute opening and closing operations in opposite directions to execute the closing operations to a fully closed position, in which the full close control unit is configured to cause the second opening and closing body to execute the closing operation at an operation speed slower than that of the first opening and closing body.

According to the above configuration, in a pair of opening and closing bodies having a double-opening configuration, one opening and closing body that preferentially reaches the fully closed position due to a structural order restriction can be set as the first opening and closing body, and can be caused to reach the fully closed position at a timing earlier than that of the other opening and closing body serving as the second opening and closing body. Accordingly, an interference between the pair of opening and closing bodies having the double-opening configuration can be prevented during the full close control.

Further, since the interference between the pair of the opening and closing bodies is prevented, a ratio of a state in which the pair of the opening and closing bodies simultaneously execute the closing operations can be increased. As a result, it is possible to reduce a so-called “waiting feeling” caused by a state in which one of the pair of opening and closing bodies having the double-opening configuration does not execute the closing operation. Accordingly, it is possible to give a good impression to a user.

It is preferable that the vehicle opening and closing body control device according to the above aspect includes an interference possibility determination unit configured to determine, by monitoring the closing operations of the first and second opening and closing bodies, a possibility that the first and second opening and closing bodies reaching the fully closed position interfere with each other, in which the full close control unit is configured to adjust, when there is a possibility of the interference, the operation speed of at least one of the first and second opening and closing bodies such that the second opening and closing body reaches the fully closed position at a later timing after the first opening and closing body reaches the fully closed position.

According to the above configuration, even in a situation with a disturbance where it is difficult to control each operation speed as desired, the second opening and closing body can be caused to reach the fully closed position at a timing later than that of the first opening and closing body. Accordingly, the interference between the pair of opening and closing bodies having the double-opening configuration can be prevented during the full close control.

It is preferable that in the vehicle opening and closing body control device according to the above aspect, the interference possibility determination unit is configured to determine that there is a possibility of the interference when the second opening and closing body reaches a second determination position preset for the second opening and closing body before the first opening and closing body reaches a first determination position preset for the first opening and closing body.

According to the above configuration, it is possible to determine, with a simple configuration, the possibility that the pair of opening and closing bodies having the double-opening configuration interfere with each other during the full close control.

It is preferable that in the vehicle opening and closing body control device according to the above aspect, the interference possibility determination unit is configured to detect a separation distance between the first and second opening and closing bodies approaching each other by the closing operations, calculate a determination value of the separation distance according to an operation position of the first opening and closing body, and determine that there is a possibility of the interference when the separation distance is smaller than the determination value.

According to the above configuration, it is possible to accurately determine the possibility that the first and second opening and closing bodies interfere with each other during the full close control.

It is preferable that in the vehicle opening and closing body control device according to the above aspect, the interference possibility determination unit is configured to detect actual operation speeds of the first and second opening and closing bodies, and determine that there is a possibility of the interference when a speed difference between the detected operation speeds is smaller than a predetermined speed difference threshold value.

According to the above configuration, it is possible to accurately determine the possibility that the first and second opening and closing bodies interfere with each other during the full close control.

It is preferable that in the vehicle opening and closing body control device according to the above aspect, the full close control unit is configured to temporarily stop the closing operation of the second opening and closing body when there is a possibility of the interference.

According to the above configuration, it is possible to more reliably delay the timing at which the second opening and closing body reaches the fully closed position. Accordingly, the interference between the pair of opening and closing bodies having the double-opening configuration can be effectively prevented.

It is preferable that in the vehicle opening and closing body control device according to the above aspect, the full close control unit is configured to restart the closing operation of the second opening and closing body when the first opening and closing body reaches a restart permission position preset for the first opening and closing body.

According to the above configuration, it is possible to effectively cause the second opening and closing body to reach the fully closed position later than the first opening and closing body.

It is preferable that in the vehicle opening and closing body control device according to the above aspect, the full close control unit is configured to control the operation speeds of the first and second opening and closing bodies by executing feedback control to cause the actual operation speeds to follow operation speed target values individually set for the first and second opening and closing bodies.

According to the above configuration, the speed difference can be set for the first and second opening and closing bodies based on the operation speed target values set individually.

It is preferable that in the vehicle opening and closing body control device according to the above aspect, the full close control unit is configured to cause the second opening and closing body to execute the closing operation at a start timing later than that of the first opening and closing body.

According to the above configuration, the interference between the pair of opening and closing bodies having the double-opening configuration can be prevented with a simple configuration.

According to this disclosure, the interference between the pair of opening and closing bodies having the double-opening configuration can be prevented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle opening and closing body control device comprising:
a full close control unit configured to cause first and second opening and closing bodies that are provided at an opening portion of a vehicle and execute opening and closing operations in opposite directions to execute the closing operations to a fully closed position, wherein
the full close control unit is configured to cause the second opening and closing body to execute the closing operation at an operation speed slower than that of the first opening and closing body.

2. The vehicle opening and closing body control device according to claim 1 comprising:
an interference possibility determination unit configured to determine, by monitoring the closing operations of the first and second opening and closing bodies, a possibility that the first and second opening and closing bodies reaching the fully closed position interfere with each other, wherein
the full close control unit is configured to adjust, when there is a possibility of the interference, the operation speed of at least one of the first and second opening and closing bodies such that the second opening and closing body reaches the fully closed position at a later timing after the first opening and closing body reaches the fully closed position.

3. The vehicle opening and closing body control device according to claim 2, wherein
the interference possibility determination unit is configured to determine that there is a possibility of the interference when the second opening and closing body reaches a second determination position preset for the second opening and closing body before the first opening and closing body reaches a first determination position preset for the first opening and closing body.

4. The vehicle opening and closing body control device according to claim 2, wherein
the interference possibility determination unit is configured to detect a separation distance between the first and second opening and closing bodies approaching each other by the closing operations, calculate a determination value of the separation distance according to an operation position of the first opening and closing body, and determine that there is a possibility of the interference when the separation distance is smaller than the determination value.

5. The vehicle opening and closing body control device according to claim 2, wherein
the interference possibility determination unit is configured to detect actual operation speeds of the first and second opening and closing bodies, and determine that there is a possibility of the interference when a speed difference between the detected operation speeds is smaller than a predetermined speed difference threshold value.

6. The vehicle opening and closing body control device according to claim 2, wherein
the full close control unit is configured to temporarily stop the closing operation of the second opening and closing body when there is a possibility of the interference.

7. The vehicle opening and closing body control device according to claim 6, wherein
the full close control unit is configured to restart the closing operation of the second opening and closing body when the first opening and closing body reaches a restart permission position preset for the first opening and closing body.

8. The vehicle opening and closing body control device according to claim 1, wherein
the full close control unit is configured to control the operation speeds of the first and second opening and closing bodies by executing feedback control to cause the actual operation speeds to follow operation speed target values individually set for the first and second opening and closing bodies.

9. The vehicle opening and closing body control device according to claim 1, wherein
the full close control unit is configured to cause the second opening and closing body to execute the closing operation at a start timing later than that of the first opening and closing body.
